(19) United States
(12) Patent Application Publication
(10) Pub. No.: US 2010/0295796 A1
(43) Pub. Date: Nov. 25, 2010

(54) DRAWING ON CAPACITIVE TOUCH SCREENS

(75) Inventors: Brian F. ROBERTS, Dallas, TX (US); Ryan Evans, Frisco, TX (US); Michael J. Naggar, Frisco, TX (US); Donald H. Relyea, JR., Dallas, TX (US); Heath Stallings, Colleyville, TX (US)

Correspondence Address: VERIZON;PATENT MANAGEMENT GROUP, 1320 North Court House Road, 9th Floor, ARLINGTON, VA, 22201-2909, US

(73) Assignee: Verizon Patent and Licensing Inc., Basking Ridge, NJ (US)

(21) Appl. No.: 12/471,160

(22) Filed: May 22, 2009

(51) Int. Cl. G06F 3/041

(52) U.S. Cl. 345/173

(57) ABSTRACT

A device includes a memory to store multiple instructions, a touch-sensitive display, and a processor. The processor executes instructions in the memory to detect a touch on the touch-sensitive display, the touch having a path of movement. The processor further executes instructions in the memory to determine a dimension of the touch and to determine locations of the touch along the path of movement. The drawing tool is displayed, on the touch-sensitive display, at a fixed distance outside the dimension of the touch, the drawing tool having a path being associated with the path of movement of the touch. A fixed graphical image corresponding to the drawing tool path is generated.

### BACKGROUND

Capacitive touch screens typically rely on current from a body part (e.g., a finger) to receive user input. However, a finger generally lacks the precision required for drawing applications. More precise devices for drawing applications, such as a stylus or even a fingernail, cannot be used as an input device on capacitive touch screens.

### BRIEF DESCRIPTION OF THE DRAWINGS

FIG. 1 is a diagram illustrating an exemplary implementation of a drawing interface for a capacitive touch screen;

FIG. 2 depicts a diagram of an exemplary device in which systems and/or methods described herein may be implemented;

FIG. 3 depicts a diagram of exemplary components of the device illustrated in FIG. 2;

FIG. 4 depicts a diagram of exemplary functional components of the device illustrated in FIG. 2;

FIGS. 5A and 5B illustrate exemplary touch areas on the surface of the device depicted in FIG. 2;

FIG. 6 depicts a flow chart of an exemplary process for drawing on a capacitive touch screen according to implementations described herein; and

FIG. 7 provides an illustration of another exemplary implementation of a drawing interface for a capacitive touch screen.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may provide a drawing interface to aid in precision for drawing on capacitive touch screens. Upon activation of a drawing interface, sensing points may be used to determine a location, dimensions, and/or orientation for a touch (e.g., by a finger) on the touch screen. A drawing tool may be displayed extended beyond the touch location to provide a precise drawing tip based on the location of the touch. The drawing tool may generate graphics (e.g., a line, shape or other graphic) and may move as an apparent extension of the user's finger as the touch is dragged along the surface of the touch screen.

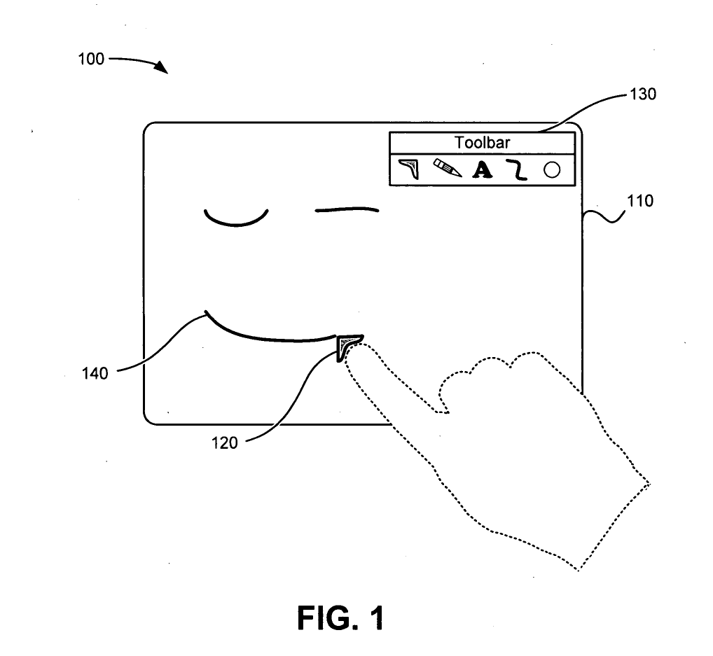

FIG. 1 provides a diagram illustrating an exemplary implementation of a drawing interface 100 for a capacitive touch screen. Drawing interface 100 may include a touch screen 110, a drawing tool 120, and a toolbar 130. Drawn objects 140 may be shown on touch screen 110 based on user input using drawing tool 120.

Touch screen 110 may include devices and/or logic that can be used to display images to a user of drawing interface 100 and to receive user inputs in association with the displayed images. For example, drawing tool 120, toolbar 130, drawn objects 140, icons, virtual keys, or other graphical elements may be displayed via touch screen 110.

Drawing tool 120 may include a pointer, tip, brush or other indicator associated with the location and/or orientation of a touch. Drawing tool 120 may be located on display 110, for example, to appear as an extension of a finger. As described further herein, a touch on touch screen 110 may include multiple sensing points. The multiple sensing points may be analyzed to determine dimension(s), location, and orientation of the touch. Drawing tool 120 may then be displayed in a location associated with the touch and removed from the actual touch area so as to be visible to a user. As the touch is dragged along the surface of touch screen 110, drawing tool 120 may generate drawn objects (e.g., drawn object 140) that correspond to the location of drawing tool 120. In one implementation, removal of the touch from touch screen 110 may cause drawing tool 120 to be removed from view on touch screen 110.

Toolbar 130 may include a variety of menu items, icons, and/or other indicators (generically referred to herein as “tips”) that may represent multiple shapes for drawing tool 120. Tips may include for example, multiple line thicknesses, spray paint simulations, brushes, polygons, text boxes, erasers, lines and other graphics. A tip may be selected from toolbar 130 by a user (e.g., by touching a tip on toolbar 130). The selection of a particular tip from toolbar 130 may change the appearance and/or drawing properties of drawing tool 120.

Although FIG. 1 shows an exemplary drawing interface 100, in other implementations, drawing interface 100 may contain fewer, different, differently arranged, or additional items than depicted in FIG. 1. For example toolbar 130 can be included on a separate interface screen of touch screen 110 or displayed as a pull-down menu. Also, drawing tool 120 may be associated with the location of a touch in a manner other than appearing as an extension of a finger performing the touch.

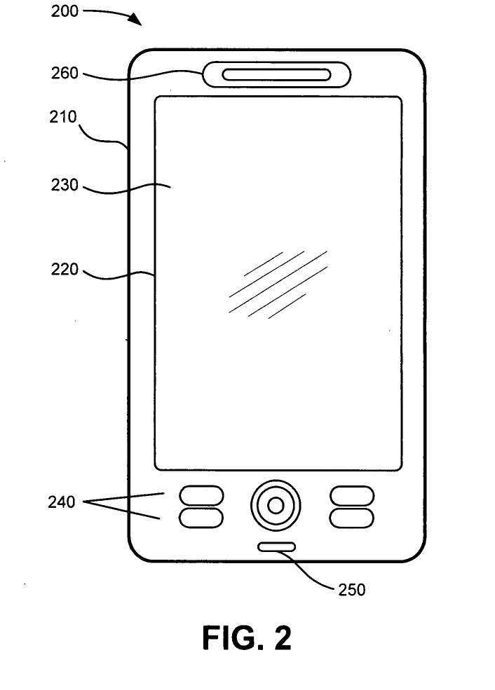

FIG. 2 is a diagram of an exemplary device 200 in which systems and/or methods described herein may be implemented. Device 200 may include a radiotelephone, a personal communications system (PCS) terminal (e.g., that may combine a cellular radiotelephone with data processing and data communications capabilities), a PDA (e.g., that can include a radiotelephone, a pager, Internet/intranet access, etc.), a portable gaming system, a personal computer, a laptop computer, a tablet device and/or any other device capable of utilizing a touch screen display.

As illustrated in FIG. 2, device 200 may include a housing 210, a display 220, a touch panel 230, control buttons 240, a microphone 250, and/or a speaker 260. Housing 210 may protect the components of device 200 from outside elements. Housing 210 may include a structure configured to hold devices and components used in device 200, and may be formed from a variety of materials. For example, housing 210 may be formed from plastic, metal, or a composite, and may be configured to support display 220, touch panel 230, control buttons 240, microphone 250, and/or speaker 260.

Display 220 may provide visual information to the user. For example, display 220 may display text input into device 100, text, images, video, and/or graphics received from another device, and/or information regarding incoming or outgoing calls or text messages, emails, media, games, phone books, address books, the current time, etc. For example, display 220 may include a liquid crystal display (LCD), such as a thin film transistor (TFT) LCD, etc.

As shown in FIG. 2, touch panel 230 may be integrated with and/or overlaid on display 220 to form a touch screen (e.g., touch screen 110) or a panel-enabled display that may function as a user input interface. For example, in one implementation, touch panel 230 may include near field-sensitive (e.g., capacitive) technology, acoustically-sensitive (e.g., surface acoustic wave) technology, photo-sensitive (e.g., infra-red) technology, pressure-sensitive (e.g., resistive) technology, force-detection technology and/or any other type of touch panel overlay that allows display 220 to be used as an input device.

Generally, touch panel 230 may include any kind of technology that provides the ability to identify multiple touches and/or a sequence of touches that are registered on the surface of touch panel 230. Touch panel 230 may also include the ability to identify movement of a body part or a pointing device as it moves on or near the surface of touch panel 230.

In one embodiment, touch panel 230 may include a capacitive touch overlay including multiple touch sensing points capable of sensing a touch. An object having capacitance (e.g., a user's finger) may be placed on or near touch panel 230 to form a capacitance between the object and one or more of the touch sensing points. The amount and location of touch sensing points may be used to determine touch coordinates (e.g., location and dimensions) of the touch. The touch coordinates may be associated with a portion of display 220 having corresponding coordinates.

In another embodiment, touch panel 230 may include projection scanning technology, such as infra-red touch panels or surface acoustic wave panels that can identify, for example, dimensions of a human touch on the touch panel. For either infra-red or surface acoustic wave panels, the number of horizontal and vertical sensors (e.g., acoustic or light sensors) detecting the touch may be used to approximate the location of a touch.

Control buttons 240 may permit the user to interact with device 200 to cause device 200 to perform one or more operations. For example, control buttons 240 may be used to cause device 200 to transmit information and/or to activate drawing interface 100 on display 230.

Microphone 250 may receive audible information from the user. For example, microphone 250 may receive audio signals from the user and may output electrical signals corresponding to the received audio signals. Speaker 260 may provide audible information to a user of device 200. Speaker 260 may be located in an upper portion of device 200, and may function as an ear piece when a user is engaged in a communication session using device 200. Speaker 260 may also function as an output device for music and/or audio information associated with games and/or video images played on device 200.

Although FIG. 2 shows exemplary components of device 200, in other implementations, device 200 may contain fewer, different, differently arranged, or additional components than depicted in FIG. 2. For example, in some implementations device 200 may include a keypad, such as a standard telephone keypad, a QWERTY-like keypad (e.g., a traditional configuration of typewriter or computer keyboard keys), or another keypad layout. In still other implementations, a component of device 200 may perform one or more tasks described as being performed by another component of user device 200.

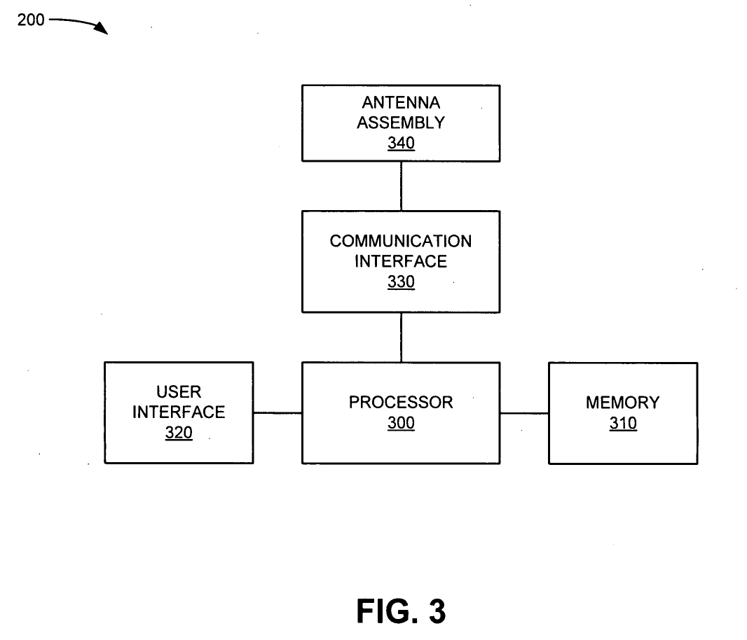

FIG. 3 is a diagram of exemplary components of device 200. As illustrated, device 200 may include a processor 300, a memory 310, a user interface 320, a communication interface 330, and/or an antenna assembly 340.

Processor 300 may include one or more microprocessors, application specific integrated circuits (ASICs), field programmable gate arrays (FPGAs), or the like. Processor 300 may control operation of device 200 and its components. In one implementation, processor 300 may control operation of components of device 200 in a manner described herein.

Memory 310 may include a random access memory (RAM), a read-only memory (ROM), and/or another type of memory to store data and instructions that may be used by processor 300. In one implementation, memory 310 may store data used to display a graphical user interface, such as quick-access menu arrangement 100 on display 230.

User interface 320 may include mechanisms for inputting information to device 200 and/or for outputting information from device 200. Examples of input and output mechanisms might include buttons (e.g., control buttons 240, keys of a keypad, a joystick, etc.); a speaker (e.g., speaker 220) to receive electrical signals and output audio signals; a microphone (e.g., microphone 250) to receive audio signals and output electrical signals; a display (e.g., display 230) to receive touch input and/or to output visual information; a vibrator to cause device 200 to vibrate; and/or a camera to receive video and/or images.

Communication interface 330 may include, for example, a transmitter that may convert baseband signals from processor 300 to radio frequency (RF) signals and/or a receiver that may convert RF signals to baseband signals. Alternatively, communication interface 330 may include a transceiver to perform functions of both a transmitter and a receiver. Communication interface 330 may connect to antenna assembly 340 for transmission and/or reception of the RF signals.

Antenna assembly 340 may include one or more antennas to transmit and/or receive RF signals over the air. Antenna assembly 340 may, for example, receive RF signals from communication interface 330 and transmit them over the air, and receive RF signals over the air and provide them to communication interface 330. In one implementation, for example, communication interface 330 may communicate with a network and/or devices connected to a network.

As will be described in detail below, device 200 may perform certain operations described herein in response to processor 300 executing software instructions of an application contained in a computer-readable medium, such as memory 310. A computer-readable medium may be defined as a physical or logical memory device. A logical memory device may include a space within a single physical memory device or spread across multiple physical memory devices. The software instructions may be read into memory 310 from another computer-readable medium or from another device via communication interface 330. The software instructions contained in memory 310 may cause processor 300 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 200, in other implementations, device 200 may contain fewer, different, differently arranged, or additional components than depicted in FIG. 3. In still other implementations, a component of device 200 may perform one or more other tasks described as being performed by another component of device 200.

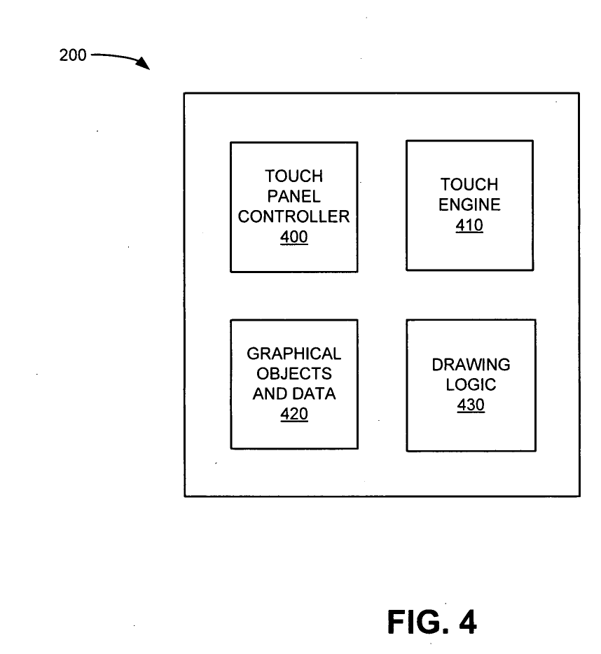

FIG. 4 provides a diagram of exemplary functional components of device 200. As shown, electronic device 100 may include touch panel controller 400, touch engine 410, graphical objects 420, and drawing logic 430.

Touch panel controller 400 may identify touch coordinates from touch panel 230. Coordinates from touch panel controller 400, including the identity of particular sensors in, for example, the X and Y dimensions, may be passed on to touch engine 410 to associate the touch coordinates with a location and/or object displayed on display 220. For example, touch panel controller may identify which sensors may indicate a touch on touch panel 230 and the location of the sensors registering the touch. In one implementation, touch panel controller 400 may be included as part of processor 300.

Touch engine 410 may include hardware or a combination of hardware and software for processing signals that are received at touch panel controller 400. More specifically, touch engine 410 may use the signal received from touch panel controller 400 to detect touches on touch panel 230 and determine dimensions, locations, and/or orientation of the touches. For example, touch engine 410 may use information from touch panel controller 400 to determine an approximate surface area of a touch. As described further herein, the touch dimensions, the touch location, and the touch orientation may be used to determine a location for a drawing object (e.g., drawing tool 120) associated with the touch. In one implementation, touch engine 410 may be included as part of processor 300.

Graphical objects and data 420 may include, for example, user preferences, images and/or templates. User preferences may include, for example, preferences for drawing settings and features, such as default drawing tip sizes/types, menu arrangements, shortcut comments, default directories, etc. Images may include, for example, definitions of stored images, such as tips for drawing tool 120, shapes, fill patterns, clip art, color palettes, and/or other drawing options that may be included on toolbar 130. Templates may include formats for drawing interface 100, such as flowcharts, maps, pictures, backgrounds, etc., which can be drawn over and/or revised on a display (e.g., display 220). Graphical objects and data 420 may be included, for example, in memory 310 (FIG. 2) and act as an information repository for drawing logic 430.

Drawing logic 430 may include hardware or a combination of hardware and software to display drawing object and drawing images based on signals from touch engine 410. For example, in response to signals that are received at touch panel controller 400, touch engine 410 may cause drawing logic 430 display drawing object 120 at a location associated with the location, dimension, and/or orientation of touch. Drawing logic 430 may also display an image (e.g., a line, a brush stroke, etc.) along the path of drawing object 120 as a touch is moved along the surface of a capacitive display (e.g., touch screen 110). More particularly, in one implementation, drawing logic 430 may connect a series of registered coordinates for drawing object 120 with a graphical image, such as a line.

Drawing logic 430 may connect each point in the series of registered coordinates using a substantially straight line between each point. However, the use of straight lines may provide a rather coarse interpolation of the motion path of a touch as it is dragged along a touch screen. Thus, drawing logic 430 may also include smoothing logic to produce a smoother curve. Smoothing logic may include, for example, spline interpolation, polynomial interpolation, curve fitting or other smoothing techniques. In another implementation, drawing logic 430 may provide different drawing-interface functions, such as selections, magnifications, placing/altering shapes, etc. Drawing logic 430 may be included as part of processor 300.

Although FIG. 4 shows exemplary functional components of device 200, in other implementations, device 200 may contain fewer, different, differently arranged, or additional functional components than depicted in FIG. 4. In still other implementations, a functional component of device 200 may perform one or more tasks described as being performed by another functional component of device 200.

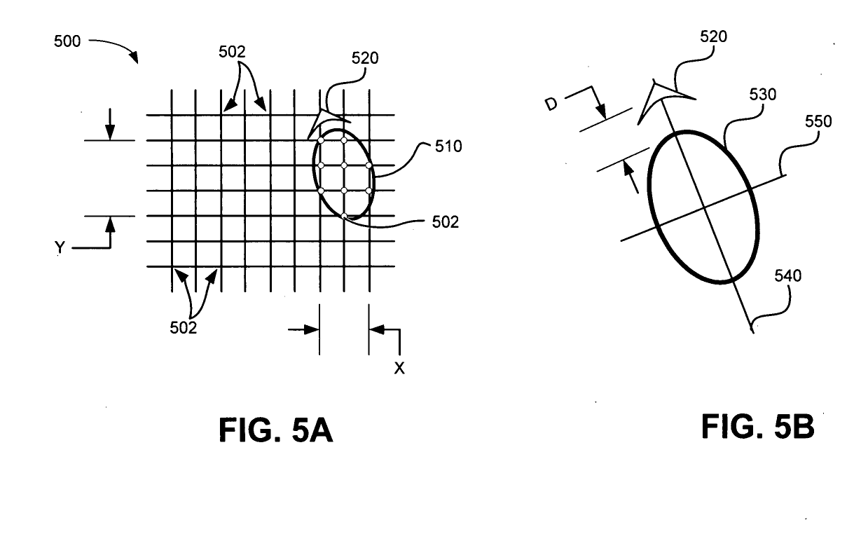

FIGS. 5A and 5B illustrate an exemplary touch area on the surface of a device, such as device 200. FIG. 5A is a diagram illustrating an exemplary touch of a right finger. FIG. 5B is an enlarged view of a best-fit ellipse approximating the touch of FIG. 5A. As described in more detail below, touch locations, dimensions, and/or orientations may be interpreted to determine placement for a drawing tool, such as drawing tool 120, on a touch screen.

Referring FIG. 5A, a touch panel (such as touch panel 230 of FIG. 1) may generally include a surface 500 configured to detect a touch at one or more sensing nodes 502. In one implementation, surface 500 may include sensing nodes 502 using a grid arrangement of transparent conductors to track approximate horizontal and vertical positions, as shown in FIG. 5A. In other implementations, other arrangements of sensing nodes 502 may be used, including polar coordinates, parabolic coordinates, non-standard coordinates, etc. The number and configuration of sensing nodes 502 may vary depending on the required accuracy/sensitivity of the touch panel. Generally, more sensing nodes can increase accuracy/sensitivity of the touch panel. A signal may be produced when a capacitive object (e.g., a user's finger) touches a region of surface 500 over a sensing node 502. Each sensing node 502 may represent a different position on surface 500 of the touch panel, and each sensing node 502 may be capable of generating a signal at the same time. When an object is placed over multiple sensing nodes 502 or when the object is moved between or over multiple sensing nodes 502, multiple signals can be generated. In one implementation, device 200 may distinguish a single touch and multiple simultaneous touches by distinguishing between signals of adjacent sensing nodes 502 and signals of disjointed nodes 502.

Still referring to FIG. 5A, a finger (or other capacitive object) may touch surface 500 in the area indicating the finger position 510. The touch may be registered at one or more sensing nodes 502 of surface 500, allowing the touch panel to identify coordinates of the touch. In one implementation, the touch coordinates may be associated with a display (e.g., display 220) underlying a touch panel (e.g., touch panel 230). In another implementation, the touch coordinates may be associated with a display located separately from surface 500.

A drawing tool location 520 may be determined based on the sensing nodes 502 within finger position 510. In the example of FIG. 5A, the number and location of sensing nodes 502 within finger position 510 may be calculated to represent a touch on a particular portion of surface 500 from a right-hand finger of a user. In an exemplary implementation, the locations of each of the sensing nodes 502 within finger position 510 may be averaged to determine a single touch point. In other implementations, the entire area the sensing nodes 502 within finger position 510 may be treated as a single touch point.

The area or approximated boundaries of finger position 510 may be calculated using the sensing nodes 502 within finger position 510. In one implementation, the locations of sensing nodes 502 within finger position 510 may be calculated to determine dimensions (e.g., X width and Y height dimensions) of the touch. In another implementation, device 200 may calculate a touch pattern to best fit sensing nodes 502 within finger position 510. For example, device 200 may calculate a best-fit ellipse to correspond to the sensing nodes 502 within finger position 510.

In an exemplary implementation, the number and location of sensing nodes 502 within finger position 510 may be calculated to determine an approach orientation of the touch that may be used to identify drawing tool location 520. For example, referring to FIG. 5B, device 200 may determine a best-fit ellipse 530 for the sensing nodes 502 within finger position 510. Best-fit ellipse 530 in FIG. 5B may approximate the actual touch area of finger position 510 in FIG. 5A. Device 200 may identify a major axis 540 and/or a minor axis 550 for ellipse 530 to estimate an approach orientation for the touch. The approach orientation may be approximated by major axis 540 of ellipse 530 and relation to the top/bottom orientation of surface 500. That is, during a touch, it may generally be presumed that a user's finger will extend from the bottom toward the top of a display surface. Thus, drawing tool location 520 for ellipse 530 may be identified at a particular distance, D, beyond ellipse 530 on major axis 540. In one implementation, distance D may be a small distance (e.g., between about 3 to 12 millimeters), suitable to displace drawing tool (e.g., drawing tool 120) from finger position 510 so as to permit a user to see the drawing tool on a display during the touch. In other implementations, distance D may be a larger or smaller distance than 3 to 12 millimeters, including a negative value. The value of D may be set as a user preference or provided as a constant setting by, for example, an original equipment manufacturer (OEM).

Although FIGS. 5A and 5B show an exemplary touch identification, in other implementations, other touch identification techniques may be used to determine a drawing tool location associated with a touch. For example, on a multi-touch capacitive panel, a first touch could be used to define a touch location and drawing tool location, while a second touch could be used to rotate the drawing tool location around the touch location.

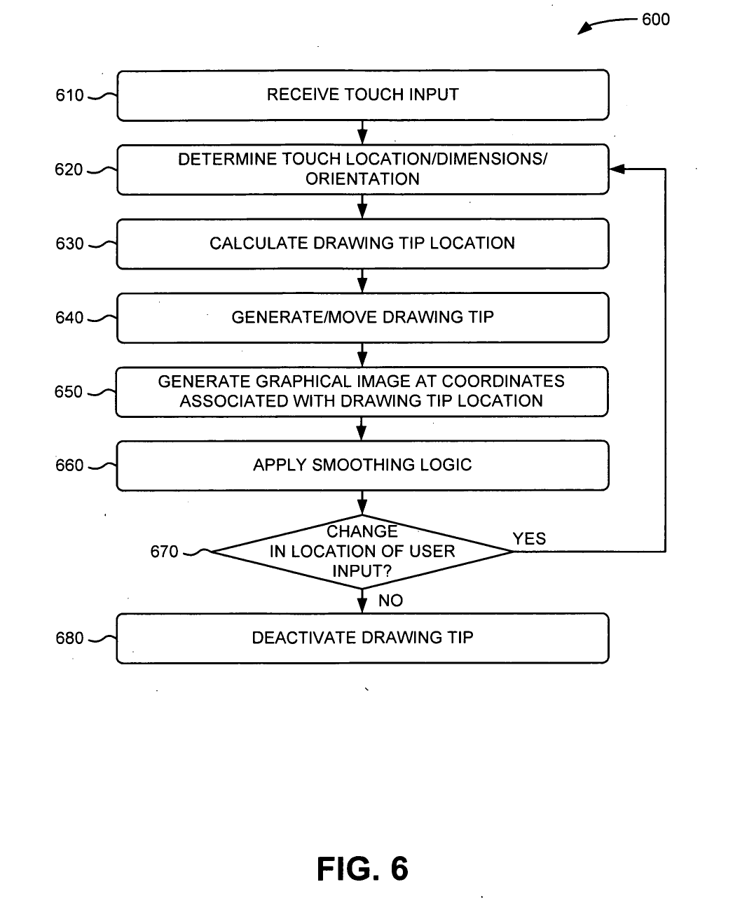

FIG. 6 depicts a flow chart of an exemplary process 600 for providing an event scheduling interface (e.g., event scheduling interface 100) according to implementations described herein. In one implementation, process 600 may be performed by device 200. In other implementations, all or part of process 600 may be performed without device 200.

A user may initiate a touch-based drawing mode to initiate process 600. As illustrated in FIG. 6, process 600 may begin with receiving a touch input (block 610) and determining the location, dimensions, and/or orientation of the touch input (block 620). For example, device 200 (e.g., touch controller 400) may detect a touch from a user's finger on a capacitive touch panel (e.g., touch panel 230). The touch may trigger multiple sensors within the touch panel that allow device 200 to approximate a touch area in a particular location of the touch screen. In one implementation, device 200 may also identify an orientation of the touch, such as described above with respect to FIGS. 5A and 5B.

A drawing tip location may be calculated (block 630), and the drawing tip may be generated or moved (block 640). For example, based on the location and orientation of the touch, device 200 (e.g., touch engine 410) may calculate a drawing tip location associated with the location of the touch input, but somewhere outside the boundaries of the touch area. Device 200 (e.g., drawing logic 430) may then apply an image representing a drawing tip at the location of calculated drawing tip location. The drawing tip may be a default drawing tip or a particular drawing tip previously selected by a user (e.g., from toolbar 130). If an image representing a drawing tip is already being displayed, device 200 may move the image to the updated location.

A graphical image may be generated at coordinates associated with the drawing tip location (block 650). For example, device 200 (e.g., drawing logic 430) may apply a graphical image to join a previous drawing tip location to a current drawing tip location, thus forming a line between the two locations. The graphical image may be an image associated with the selected (or default) drawing tip. For example, one drawing tip may be associated with a small circular image (e.g., representing a sharp pencil), while another drawing tip may be associated with a larger circular image (e.g., representing a marker).

Smoothing logic may be applied (block 660). For example, device 200 (e.g., drawing logic 430) may apply smoothing logic to one or more segments of the graphical image. Smoothing logic may alter the connecting segments to provide a more visually pleasing result on the device display. In some implementations, application of smoothing logic may be optional.

It may be determined if there is a change to the location of the user input (block 670). For example, device 200 (e.g., touch panel controller 400) may detect a user's dragging the touch along the surface of the touch panel. Alternatively, the touch may be removed from the touch panel. If it is determined that there is a change to the location of the user input (block 670—YES), process 600 may return to block 620. If it is determined that there is no change to the location of the user input (block 670—NO), the drawing tip may be deactivated (block 690). For example, when device 200 (e.g., touch controller 400) detects that no touch sensors are active, device 200 (e.g., drawing logic 430) may remove the drawing tip from the display. The graphical image associated with the drawing tip may remain on the display.

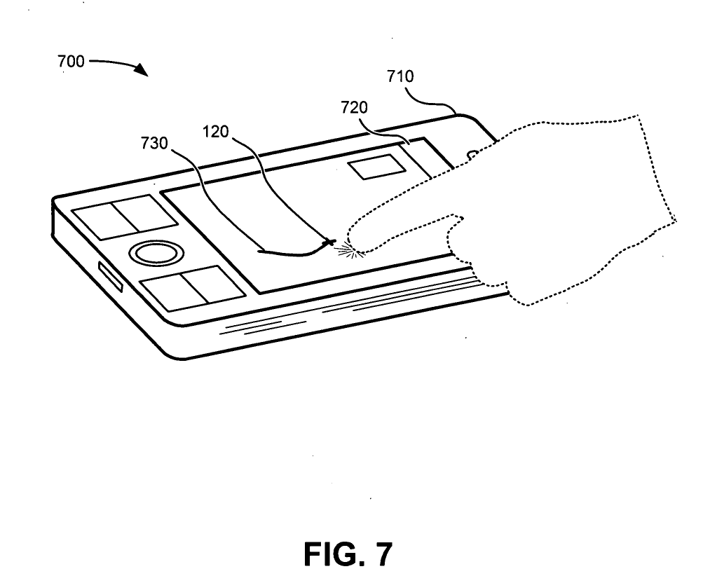

FIG. 7 provides an illustration of exemplary user input for a drawing interface on a capacitive touch screen. Referring to FIG. 7, device 700 may include housing 710 and a touch-sensitive display 720. Other components, such as control buttons, a microphone, connectivity ports, memory slots, and/or speakers may be located on device 700, including, for example, on a rear or side panel of housing 710. Although FIG. 7 shows exemplary components of device 700, in other implementations, device 700 may contain fewer, different, differently arranged, or additional components than depicted in FIG. 7.

Touch-sensitive display 720 may include a display screen integrated with a touch-sensitive overlay. In an exemplary implementation, touch-sensitive display 720 may include a capacitive touch overlay. An object having capacitance (e.g., a user's finger) may be placed on or near display 720 to form a capacitance between the object and one or more of the touch sensing points. The touch sensing points may be used to determine touch coordinates (e.g., location), dimensions, and/or orientation of the touch. In other implementations, different touch screen technologies that accept a human touch input may be used.

Touch-sensitive display 720 may include the ability to identify movement of an object as the object moves on the surface of touch-sensitive display 720. As described above with respect to, for example, FIGS. 5A and 5B, device 700 may include a drawing interface that displays a drawing tool (e.g., drawing tool 120) in a location associated with the user's touch. In the implementation shown in FIG. 7, a user may apply a touch to touch-sensitive display 720 and drag the touch. Device 700 may cause drawing tool 120 to follow the touching/dragging motion and may generate a graphic 730 along the path of drawing tool 120. Optionally, smoothing logic may be applied to graphic 730. While shown on a blank screen in FIG. 7, in other implementations, graphic 730 may be applied over images, such as photographs, maps, etc.

Systems and/or methods described herein may include detecting a touch from a user's finger on the touch-sensitive display, the touch having a path of movement. A location, dimensions and/or orientation of the touch may be determined. A drawing tool may be displayed, on the touch-sensitive display, at a fixed distance outside an area of the touch, where the area of the touch may be determined based on the determined dimensions and/or orientation. The drawing tool may thus have a path of movement that is different than, but associated with, the path of movement of the touch. A fixed graphical image corresponding to the drawing tool path can be generated to provide a precise drawing interface.

The foregoing description of implementations provides illustration and description, but is not intended to be exhaustive or to limit the invention to the precise form disclosed. Modifications and variations are possible in light of the above teachings or may be acquired from practice of the invention.

For example, while implementations have been described primarily in the context of a touch-screen enabled mobile device (such as a radiotelephone, a PCS terminal, or a PDA), in other implementations the systems and/or methods described herein may be implemented on other touch-screen computing devices such as a laptop computer, a personal computer, a tablet computer, an ultra-mobile personal computer, or a home gaming system.

Also, while a series of blocks has been described with respect to FIG. 6, the order of the blocks may be modified in other implementations. Further, non-dependent blocks may be performed in parallel.

It will be apparent that aspects described herein may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware may be designed to implement these aspects based on the description herein.

Further, certain portions of the invention may be implemented as “logic” that performs one or more functions. This logic may include hardware, such as an application specific integrated circuit or a field programmable gate array, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computing-device implemented method, comprising:
detecting a touch on a surface of a capacitive touch screen of the computing device;
determining, by the computing device, a location of the touch on the surface of the touch screen;
determining, by the computing device, dimensions of the touch on the surface of the touch screen;
calculating a location of a drawing tip associated with the location of the touch, the calculated location of the drawing tip being outside the dimensions of the touch;
displaying, on the touch screen, a drawing tip image at the calculated location of the drawing tip; and
displaying, on the touch screen, a fixed graphical image at the location of the drawing tip.

2. The computing device-implemented method of claim 1, further comprising:
determining, by the computing device, an orientation of the touch on the surface of the touch screen, where the calculated location of the drawing tip is based on the orientation of the touch.

3. The computing device-implemented method of claim 1, further comprising:
detecting, by the computing device, a change in the location of the touch on the surface of the touch screen;
calculating another location of a drawing tip associated with the changed location of the touch, the calculated another location of the drawing tip being outside the dimensions of the touch;
relocating the drawing tip image to the calculated another location of the drawing tip; and
displaying, on the touch screen, a fixed graphical image connecting the location of the drawing tip to the calculated another location of the drawing tip.

4. The computing device-implemented method of claim 3, further comprising:
applying smoothing logic to the fixed graphical image connecting the location of the drawing tip to the calculated another location of the drawing tip.

5. The computing device-implemented method of claim 1, where the drawing tip appears on the touch screen as an extension of the user's finger.

6. The computing device-implemented method of claim 1, where the location of the drawing tip is recalculated as the touch moves along the surface of the touch screen.

7. The computing device-implemented method of claim 1, where the fixed graphical image is a drawing shape.

8. The computing device-implemented method of claim 1, further comprising:
detecting another touch from another user's finger on the surface of the capacitive touch screen of the computing device; and
interpreting the other touch as input for the calculated location of the drawing tip.

9. The computing device-implemented method of claim 1, further comprising:
detecting another touch on the surface of the capacitive touch screen of the computing device; and
interpreting the other touch as input for a selection of a type of drawing tip.

10. The computing device-implemented method of claim 1, further comprising:
removing the drawing tip from the display on the touch screen upon removal of the touch.

11. A device, comprising:
a memory to store a plurality of instructions;
a touch-sensitive display; and
a processor to execute instructions in the memory to:
detect a touch on the touch-sensitive display, the touch having a path of movement,
determine a dimension of the touch,
determine locations of the touch along the path of movement,
display, on the touch-sensitive display, a drawing tool at a fixed distance outside the dimension of the touch, the drawing tool having a path being associated with the path of movement of the touch, and
generate a fixed graphical image corresponding to the drawing tool path.

12. The device of claim 11, where the processor further executes instructions in the memory to:
detect removal of the touch from the touch-sensitive display, and
stop displaying the drawing tool based on the removal of the touch.

13. The device of claim 11, where the processor further executes instructions in the memory to:
determine an approach orientation of the touch, and calculate a position of the drawing tip is based on the orientation of the touch.

14. The device of claim 13, where the position of the drawing tip is recalculated as the touch moves along the path of movement.

15. The device of claim 11, where the processor further executes instructions in the memory to:
detect another touch from another user's finger on the surface of the touch-sensitive display; and
interpreting the other touch as input for the position of the drawing tip.

16. The device of claim 11, where the drawing tip appears on the touch screen as an extension of the user's finger.

17. The device of claim 11, where the fixed graphical image is one of a line, shape or a selection box.

18. The device of claim 11, where the dimension of the moving touch includes a surface area of the touch at a particular point in time.

19. A device, comprising:
means for detecting a touch from a capacitive object on a touch screen;
means for determining a location of the touch on the touch screen;
means for determining an area of the touch on the touch screen;
means for calculating a location of a drawing tool associated with the location of the touch, the calculated location of the drawing tool being outside the area of the touch;
means for displaying, on the touch screen, a drawing tip at the calculated location of the drawing tip;
means for displaying, on the touch screen, a fixed graphical image at the location of the drawing tip.

20. The device of claim 19, further comprising:
means for determining an approach orientation of the touch, where the means for calculating the location of the drawing tool is based on the orientation of the touch.
